(19) United States
(12) Patent Application Publication
(10) Pub. No.: US 2017/0251024 A1
(43) Pub. Date: Aug. 31, 2017

(54) SYSTEM AND METHOD FOR SHARED PARAMETER-LEVEL DATA

(71) Applicant: Michael HATHAWAY, Austin, TX (US)

(72) Inventor: Michael HATHAWAY, Austin, TX (US)

(21) Appl. No.: 15/443,334

(22) Filed: Feb. 27, 2017

Related U.S. Application Data
(60) Provisional application No. 62/299,759, filed on Feb. 25, 2016.

(51) Int. Cl. H04L 29/06; G06F 21/64; H04L 9/32; G06F 21/60

(52) U.S. Cl. CPC H04L 63/20; G06F 21/602; G06F 21/64; H04L 63/18; H04L 63/102; H04L 63/06; H04L 63/0428; H04L 9/3263

(57) ABSTRACT

A computationally implemented method includes, but is not limited to: configuring a centrally administered data template including one or more data parameters, each of the one or more data parameters configured to be exchanged between one or more remote computing environments; assigning access permissions for each of the one or more data parameters to enable one or more requestors to access or exchange the one or more data parameters; and individually encrypting the one or more data parameters as individual database fields in to enable each of the one or more requestors with a cryptographic key that identifies each of the one or more requestors as qualified to retrieve the one or more data parameters via an API query. In addition to the foregoing, other method aspects are described in the claims, drawings, and text forming a part of the present disclosure.

### FIELD OF INVENTION

This invention relates generally to the field of network-connected systems and centrally managed access permissions for distributed access points.

### SUMMARY

A system that enables the owner of information sources, including but not limited to network connected devices, systems, software applications or databases, to centrally manage the access permissions and security of information associated with these sources, that is shared with users, software applications, systems, devices and databases via a network connection network, thus enabling information to be filtered, enhanced and/or anonymized uniquely at one or more access points. In one embodiment, the system incorporates a method to encrypt data stored on a database, while maintaining searchability on the encrypted database. Lastly, the invention establishes centralized administration where information administrators and owners can manage information access permissions, encryption and security policies across distributed information sources, sinks, applications, databases and data storage services.

One embodiment relates to a system that facilitates filtering and modification of database fields as parameters and/or records associated with an information source, through the creation and editing of information profile templates, which can be distributed and synchronized at the information source or at managed API access points.

One embodiment provides for a method that includes, but is not limited to configuring a centrally administered data template including one or more data parameters, each of the one or more data parameters configured to be exchanged between one or more remote computing environments; assigning access permissions for each of the one or more data parameters to enable one or more requestors to access or exchange the one or more data parameters; and individually encrypting the one or more data parameters as individual database fields in to enable each of the one or more requestors with a cryptographic key that identifies each of the one or more requestors as qualified to retrieve the one or more data parameters via an API query. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware in one or more machines or article of manufacture configured to effect the herein-referenced method aspects depending upon the design choices of the system designer.

A system includes, but is not limited to: means for configuring a centrally administered data template including one or more data parameters, each of the one or more data parameters configured to be exchanged between one or more remote computing environments; means for assigning access permissions for each of the one or more data parameters to enable one or more requestors to access or exchange the one or more data parameters; and means for individually encrypting the one or more data parameters as individual database fields in to enable each of the one or more requestors with a cryptographic key that identifies each of the one or more requestors as qualified to retrieve the one or more data parameters via an API query. In addition to the foregoing, other system aspects are described in the claims, drawings, and text forming a part of the present disclosure.

A computationally implemented system includes, but is not limited to: circuitry for configuring a centrally administered data template including one or more data parameters, each of the one or more data parameters configured to be exchanged between one or more remote computing environments; circuitry for assigning access permissions for each of the one or more data parameters to enable one or more requestors to access or exchange the one or more data parameters; and circuitry for individually encrypting the one or more data parameters as individual database fields in to enable each of the one or more requestors with a cryptographic key that identifies each of the one or more requestors as qualified to retrieve the one or more data parameters via an API query. In addition to the foregoing, other system aspects are described in the claims, drawings, and text forming a part of the present disclosure. In addition to the foregoing, other method aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows an exemplary computing environment capable of implementing one or more embodiments in accordance with the present application.

FIGS. 2a and 2b illustrate a particular implementation of the system of shared parameter level data created by the computing environment of FIG. 1 in accordance with the present application.

FIG. 3 is a high-level logic flowchart of a process depicting an implementation of a method of the present application.

FIG. 4 is a high-level logic flowchart of a decision tree depicting an implementation of a method of the present application.

FIG. 5 is a high-level logic flowchart of a decision tree depicting an implementation of a method of the present application.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with various embodiments, computationally implemented methods, systems, and articles of manufacture are provided.

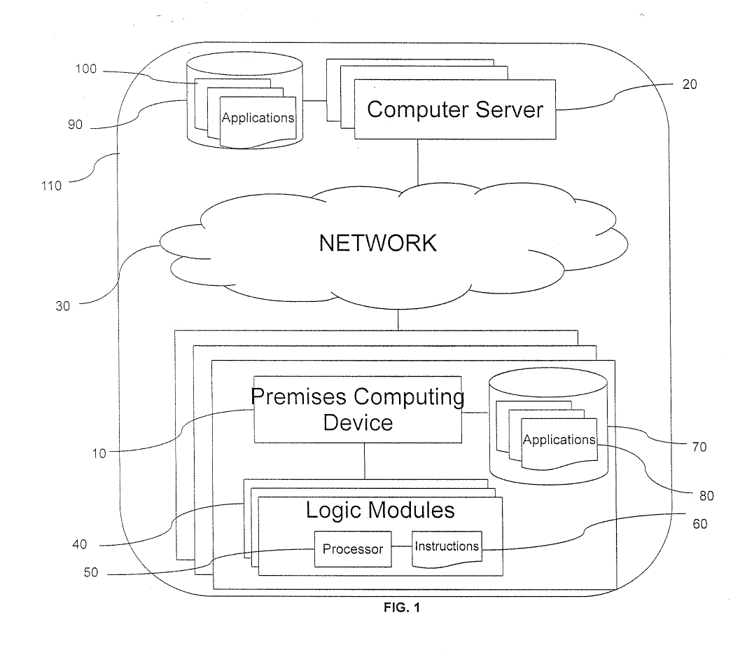

Referring now to FIG. 1, the figure illustrates one or more premises computing devices 10 connected via a network interface, connects to a network 30 to one or more computer servers 20 in an exemplary environment 110. As will be further described herein the illustrated premises computing device 10 and computer server 20 may employ the computationally implemented methods, systems, and articles of manufacture in accordance with various embodiments. The premises computing device 10 and computer server 20, in various embodiments, enable functions of premises computing devices 10 and computer servers 20.

FIG. 1 also illustrates logic modules 40 implemented using circuit components. Logic modules 40 may be implemented using a combination of specifically designed circuitry such as ASICs and one or more processors 50 (or other types of circuitry such as field programmable gate arrays or FPGAs) executing computer readable instructions 60. Logic modules can function as sensors, controls or devices that generate, receive and/or process digital data. System requirements could dictate a combination of software and firmware and circuitry to meet the embodiments herein, for example, logic modules could be designed to use the most efficient combination of software/hardware/firmware in order to quickly implement methods and systems within the scope of the present disclosure.

In various embodiments, the memory 70 of the computing device 10 of FIG. 1 may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In various embodiments, the one or more applications 80 stored in memory 70 may include, for example, an operating system, one or more communications applications, database applications and applications including but not limited to data analysis, management visualization and storage.

Also, in various embodiments, the memory 90 of the computer server 20 of FIG. 1 may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In various embodiments, the one or more applications 100 stored in memory 90 may include, for example, an operating system, communications applications, database applications and applications including but not limited to data analysis, management visualization and storage.

The digital information landscape presents a diverse array of information sources generated from, and shared with other network connected devices, software applications, services and systems. The growth of Cloud platforms to address the diversity of information presented by Machine-to-Machine (M2M) and Internet of Things (IoT) devices offers a centralized method for managing the complexity of this information as well as offering some operational and cost efficiencies. Reliance solely on Cloud services, however, presents privacy and security concerns of customers who are hesitant to share access to information and controls of sensitive and mission critical devices and systems with servers and platforms that exist outside the control of their enterprise. The system(s) described in herein establishes the concept of “information ownership” and facilitates the centralized management and enforcement of privacy and security policies down to the parameter level across distributed data access points within a network.

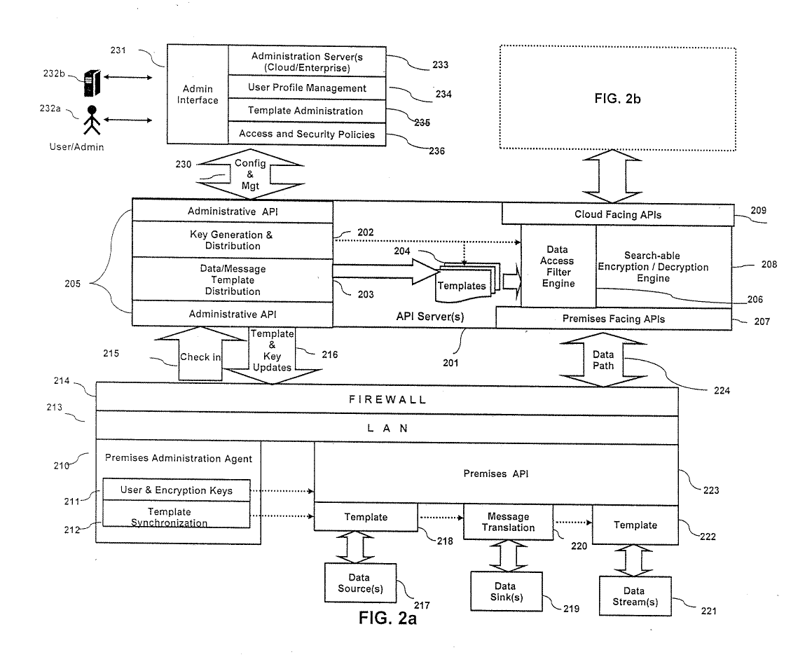

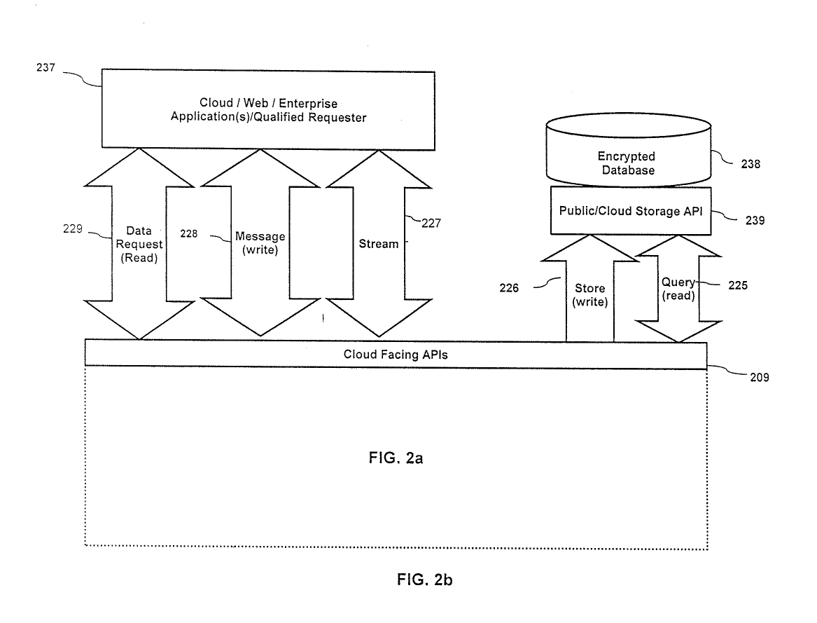

Referring now to FIG. 2, the system in accordance with an embodiment includes administrative servers 233, application programming interface (API) servers 201, and premise level services located within a local area network (LAN). Administrative servers 233 can provide a human and machine interfaces for the uploading, managing, viewing, editing and overall management of policies and profiles.

For example, the interfaces can include information source template profiles 204 that can be viewable in a chart format, uploaded via a machine interface, representing data from a source, where administrator or an automated process can modify records and fields within a record to filter 206 or limit information access at a record or parameter level, enhance data, and/or anonymize data. Templates can be distributed to one or more access points where it is used to modify stored or streaming data source prior to transport to a recipient. Referring to FIG. 2, Firewall 214 and LAN 213 along with the associated premises API 223 and premises administration agent 210 illustrates a sample access point. As one of skill in the art with the benefit of this disclosure will appreciate, multiple firewalls and LANs can be coupled to API servers as multiple access points over an internet connection.

Administrative servers 233 further establish and maintain access administration policies that enable management of users, classes of recipients and information sharing policies, which equates to a user or user class identifier and its association with a specific template, data stream or data collection. Referring to FIG. 2, more specifically, user interface 231 allows a user or administrator machine 232a and/or 232b to access administrative server 233, user profile management 234, and template administration 235.

Administrative servers 233 also provide encryption and access key management and policies 236 that issue and revoke access keys for users and classes of users used to enforce information access at access points such as premises outside of firewall 214 that are part of the system. Administrative servers 233 can also store encryption keys used to encrypt data stored on databases and digital storage systems. Administrative servers 233 can also manage certificates for encrypted communications channels including but not limited to SSL certificates.

API servers 201 function to provide access to information via a suite of network services to individual or classes of users. For example, API server 201 can distribute access keys, certificates and encryption keys to users and managed API access points/premises 210.

API servers 201 also distribute and synchronize information templates 204 for managed access points/premises 210. API servers 201 further provide dynamic filtering of source information and/or messaging templates 204 via data access filter engine 206 that are to be transferred to a target device or system.

Premises facing API 207 and Cloud/Web/Enterprise facing API 209 include dynamic filtering of source information or messaging templates to be transferred to a target device or system to which they are coupled. Premises facing API 207 is coupled via data path 224 to premises locations; cloud facing APIs 209 is coupled via stream path 227 to Cloud/Web/Enterprise Applications/Requestors 237.

In one embodiment, Database encryption/decryption service where database fields are encrypted prior to storing on a target database server and query search terms are encrypted for the purposes of the query, and resulting data returned is decrypted prior to transport to a qualified requestor-subscriber, 237. The ability to searching encrypted data prevents a storage provider from being able to exploit their data.

In one embodiment, one or more premises are coupled via a firewall 214 and a LAN 213. Premises services functions as a distributed information access point within the system. Services consist of one or more Premises Administration Agents 210 managed Premises APIs 223, which can be deployed as software running on a computing device on a customer premises LAN 213.

Premises Services functions can include, but are not limited to management of certificates, API access keys and encryption keys 211 used for transport of secured information between Premises and other systems on a network or LAN 213. Premises services via premises administration agent 210 can also include management of templates 218, 222 and associated data structures for coordinating the filtering, modification, enhancement and translation of information and messaging between data sources 218, data sinks (recipients) 219, and streaming data sources 221 connected to the premises network 213.

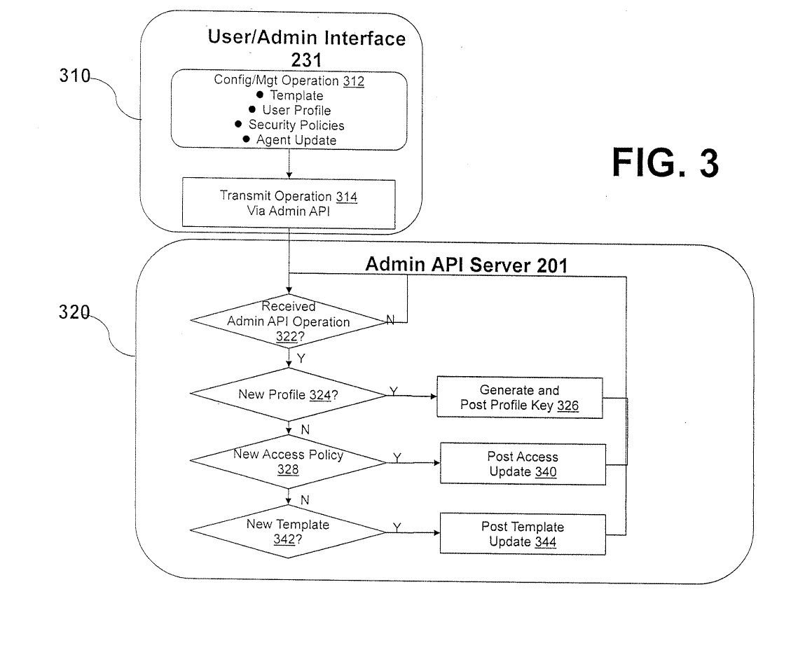

Referring now to FIG. 3, a flow diagram illustrates the interactions between User/Administrative Interface 231 and Administrative API Server 201. As shown in box 310, User/Administrative Interfaced 231 includes configuration and management operations for templates, user profiles, security policies, and agent updates 312. Once configured, transmit operation 314 provides the relevant profiles, policies, templates and updates to administrative API server 201.

Administrative API sever 201 performs the decision flow operations as shown in block 320, including determining if an Administrative API operation was received 322, and whether a new profile was received 324. If a new profile is received, block 326 provides for generating and posting a profile key. If a new access policy is received 328, block 340 provides for posting access updates. If a new template is received 342, block 344 provides for posting template updates.

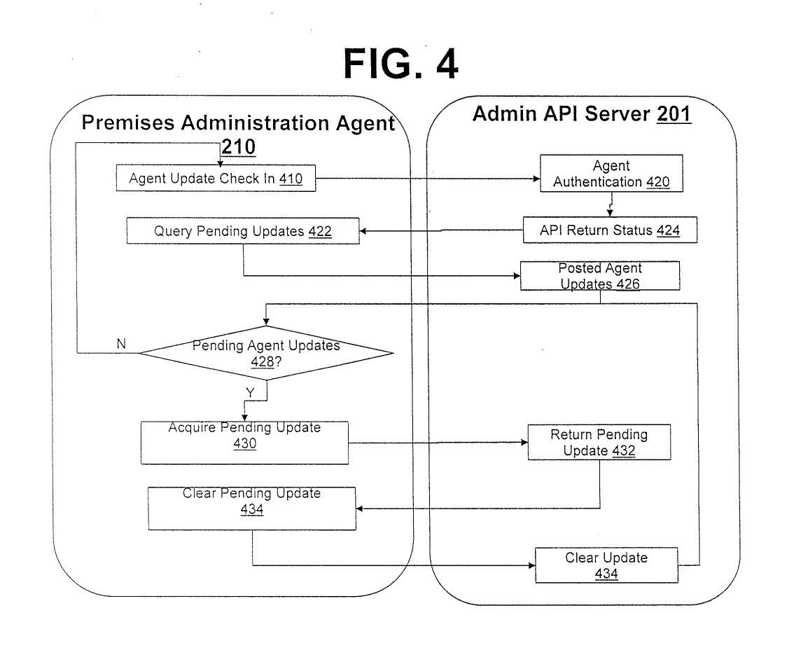

Referring now to FIG. 4, a flow diagram illustrates the interactions between premises administration agent 210 and Administrative API Server 201. As shown, a premises agent can perform a check in 410 by authenticating as an agent 420. Administrative API server returns a status 424 if authentication is valid. Premises Administration Agent 210 then can query for pending updates 422, which generates posted agent updates 426 from the Administrative API Server 201. Decision operation 428 provides for determining whether there are any pending updates. If so, block 430 provides for acquiring the pending update from the premises Administration Agent 210 and returning the pending update to the Administrative API Server 201 in block 432. Next, the pending update is cleared by the Premises Administration Agent 210 in block 434, followed by the clearing of the update at the Administrative API server 201 in block 434.

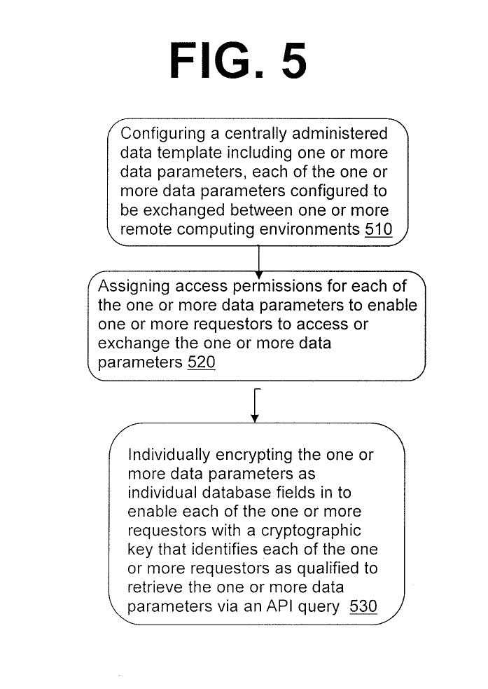

Referring now to FIG. 5, a flow diagram illustrates a method in accordance with an embodiment of the present application. Operation 510 provides for configuring a centrally administered data template including one or more data parameters, each of the one or more data parameters configured to be exchanged between one or more remote computing environments. For example, referring to FIG. 2, administration servers 233 execute administrative APIs 205 to set up profiles and templates 204 with data parameters wherein each of the data parameters can be configured to be accessed directly via premises administration agents 210 for updates and the like. In one embodiment, the data parameters are messages exchanged between the remote computing environments. In one embodiment the configuring a centrally administered data template includes establishing user profile and access and security policies. For example, administration can include assigning access permissions for each of the one or more data parameters or messages to enable one or more requestors to access or exchange the one or more data parameters to establish encryption and access key management and policies to enable issuance and revocation of access keys for one or more users. In one embodiment, the administration includes means for enforcing information access at one or more access points beyond a firewall, such as via one or more APIs. Enforcing information access can also be administrated via managing one or more secure sockets layer (SSL) cryptographic certificates for one or more encrypted communication channels.

In one embodiment, the administration includes for storing one or more encryption keys used to encrypt data stored on one or more databases, such as database 238.

Operation 520 provides for assigning access permissions for each of the one or more data parameters to enable one or more requestors to access or exchange the one or more data parameters. For example, administration servers 233 can assign access permissions for the templates set up via template administration 235 and access and security policies 236 that allow agent/premises 210 or requestors/enterprise applications via the cloud 237 to access the one or more data parameters disposed within templates 204.

Operation 530 provides for individually encrypting the one or more data parameters as individual database fields in to enable each of the one or more requestors with a cryptographic key that identifies each of the one or more requestors as qualified to retrieve the one or more data parameters via an API query. For example, administration servers 233 can individually encrypt the data parameters using access and security policies 236 as applies to templates 204 to individually encrypt data parameters within templates 204 such that an API query via premises facing API 207 or via cloud facing API 209 can query 225 encrypted database 238 via public/cloud storage API 239.

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A data parameter permission management system, comprising:
means for configuring a centrally administered data template including one or more data parameters, each of the one or more data parameters configured to be exchanged between one or more remote computing environments; and
means for assigning access permissions for each of the one or more data parameters to enable one or more requestors to access or exchange the one or more data parameters; and
means for individually encrypting the one or more data parameters as individual database fields in to enable each of the one or more requestors with a cryptographic key that identifies each of the one or more requestors as qualified to retrieve the one or more data parameters via an API query.

2. The data parameter permission management system of claim 1, wherein the one or more data parameters comprises one or more messages configured to be exchanged between the one or more remote computing environments.

3. The data parameter permission management system of claim 1, wherein the means for configuring a centrally administered data template including one or more data parameters, each of the one or more data parameters configured to be exchanged between one or more remote computing environments includes:
administration means for establishing user profile and access and security policies.

4. The data parameter permission management system of claim 1, wherein the means for assigning access permissions for each of the one or more data parameters to enable one or more requestors to access or exchange the one or more data parameters comprises:
administration means for establishing encryption and access key management and policies to enable issuance and revocation of access keys for one or more users.

5. The data parameter permission management system of claim 4, wherein the means for establishing encryption and access key management and policies to enable issuance and revocation of access keys for one or more users further comprises:
means for enforcing information access at one or more access points beyond a firewall,

6. The data parameter permission management of claim 4, wherein the means for establishing encryption and access key management and policies to enable issuance and revocation of access keys for one or more users further comprises:
administration means for storing one or more encryption keys used to encrypt data stored on one or more databases.

7. The data parameter permission management of claim 4, wherein the means for establishing encryption and access key management and policies to enable issuance and revocation of access keys for one or more users further comprises:
administration means for managing one or more cryptographic certificates for one or more encrypted communication channels.

8. The data parameter permission management of claim 7, wherein the means for managing one or more cryptographic certificates for one or more encrypted communication channels further comprises:
administration means for managing one or more secure sockets layer (SSL) cryptographic certificates for one or more encrypted communication channels.

9. A computationally-implemented system, comprising:
circuitry for configuring a centrally administered data template including one or more data parameters, each of the one or more data parameters configured to be exchanged between one or more remote computing environments;
circuitry for assigning access permissions for each of the one or more data parameters to enable one or more requestors to access or exchange the one or more data parameters; and
circuitry for individually encrypting the one or more data parameters as individual database fields in to enable each of the one or more requestors with a cryptographic key that identifies each of the one or more requestors as qualified to retrieve the one or more data parameters via an API query.

10. The data parameter permission management system of claim 9, wherein the one or more data parameters comprises one or more messages configured to be exchanged between the one or more remote computing environments.

11. The computationally-implemented system of claim 9, wherein the circuitry for configuring a centrally administered data template including one or more data parameters, each of the one or more data parameters configured to be exchanged between one or more remote computing environments further comprises:
circuitry for establishing user profile and access and security policies.

12. The computationally-implemented system of claim 9, wherein the circuitry for assigning access permissions for each of the one or more data parameters to enable one or more requestors to access or exchange the one or more data parameters comprises:
circuitry for establishing encryption and access key management and policies to enable issuance and revocation of access keys for one or more users; and
circuitry for enforcing information access at one or more access points beyond a firewall.

13. The computationally-implemented system of claim 9, wherein the circuitry for assigning access permissions for each of the one or more data parameters to enable one or more requestors to access or exchange the one or more data parameters comprises:
circuitry for storing one or more encryption keys used to encrypt data stored on one or more databases.

14. The computationally-implemented system of claim 13, wherein the circuitry for storing one or more encryption keys used to encrypt data stored on one or more databases comprises:
circuitry for managing one or more cryptographic certificates for one or more encrypted communication channels.

15. A method for administering access to data, the method comprising:
configuring a centrally administered data template including one or more data parameters, each of the one or more data parameters configured to be exchanged between one or more remote computing environments;
assigning access permissions for each of the one or more data parameters to enable one or more requestors to access or exchange the one or more data parameters; and
individually encrypting the one or more data parameters as individual database fields in to enable each of the one or more requestors with a cryptographic key that identifies each of the one or more requestors as qualified to retrieve the one or more data parameters via an API query.

16. The method of claim 15, wherein the one or more data parameters comprises one or more messages configured to be exchanged between the one or more remote computing environments.

17. The method of claim 15, wherein the assigning access permissions for each of the one or more data parameters to enable one or more requestors to access or exchange the one or more data parameters comprises:
establishing encryption and access key management and policies to enable issuance and revocation of access keys for one or more users; and
enforcing information access at one or more access points beyond a firewall.

18. The method of claim 15, wherein the assigning access permissions for each of the one or more data parameters to enable one or more requestors to access or exchange the one or more data parameters comprises:
storing one or more encryption keys used to encrypt data stored on one or more databases.

19. The method of claim 18, wherein the storing one or more encryption keys used to encrypt data stored on one or more databases comprises:
managing one or more cryptographic certificates for one or more encrypted communication channels.
